(19) United States
(12) Patent Application Publication
(10) Pub. No.: US 2015/0197135 A1
(43) Pub. Date: Jul. 16, 2015

(54) SYSTEMS FOR IMPROVING VEHICLE OCCUPANT CLIMATE COMFORT VIA STEERING ASSEMBLY AIR DELIVERY

(71) Applicant: GM GLOBAL TECHNOLOGY OPERATIONS LLC, DETROIT, MI (US)

(72) Inventors: KUO-HUEY CHEN, TROY, MI (US); TAEYOUNG HAN, BLOOMFIELD HILLS, MI (US); BAHRAM KHALIGHI, TROY, MI (US); SHAILENDRA KAUSHIK, BEVERLY HILLS, MI (US)

(73) Assignee: GM GLOBAL TECHNOLOGY OPERATIONS LLC

(21) Appl. No.: 14/593,684

(22) Filed: Jan. 9, 2015

Related U.S. Application Data
(60) Provisional application No. 61/926,550, filed on Jan. 13, 2014.

(51) Int. Cl. B60H 1/00; B60H 1/34; F25B 21/02

(52) U.S. Cl. CPC B60H 1/00021; F25B 21/02; B60H 1/34; B60H 2001/00114

(57) ABSTRACT

A system, for fostering a customized driver microclimate for a driver of a vehicle. The system includes a steering column, an input conduit, and a body connected to or constituent to the steering column. The system also includes an air-delivery port connected to the body and to the input air conduit to, during operation of the system, receive, from an air source, air to be delivered from a vicinity of the steering column toward a vicinity of the driver to foster the microclimate.

### TECHNICAL FIELD

The present disclosure relates generally to intra-vehicle air-control systems and, more particularly, to systems that are part of or connected to a vehicle steering assembly for delivering air, conditioned as desired or determined appropriate, selectively and more directly to a driver of the vehicle.

### BACKGROUND

Conventional vehicle air-delivery systems include vents located on a front dashboard of the vehicle. The vents, being positioned as such, are spaced relatively far from the driver and other passengers. The spacing allows a relatively large amount of dispersion of the air leaving the vents before it reaches the driver and any passengers.

The conventional vents, vent positioning, and resulting air dispersion are not shortcomings inherently. They have benefits including delivering the conditioned air to generally an entirety of the cabin when desired. The present technology has been developed to accomplish distinct heating, ventilating, and air conditioning benefits that cannot be achieved by conventional systems, including directing air, conditioned as desired or determined appropriate, selectively and more directly to the driver of the vehicle.

### SUMMARY

The present disclosure relates in one aspect to an intra-vehicle air-control system. The system is a part of, or connected to, a vehicle steering assembly for delivering air, conditioned as desired or determined appropriate, selectively and more directly to a driver of the vehicle.

Other aspects of the present invention will be in part apparent and in part pointed out hereinafter.

### DESCRIPTION OF THE DRAWINGS

FIG. 1 is a perspective view of an air-delivery system installed in combination with a vehicle steering assembly, according to an embodiment of the present disclosure.

FIG. 2 is a perspective view of the air-delivery system, of FIG. 1, separate from the steering assembly.

FIG. 3 is a close-up view of one of the air-delivery components of the air-delivery system of FIG. 1.

FIG. 4 is a driver-perspective view of the air-delivery system of FIG. 1 installed on a vehicle.

FIG. 5 is a perspective view showing a control mechanism, for activating or adjusting the air-delivery system, mounted on an instrument cluster hood of the vehicle.

FIG. 6 is a driver-perspective view, like that of FIG. 4, of a vehicle having installed thereon an air-delivery system according to another embodiment of the present technology.

FIG. 7 is a perspective view of an embodiment in which steering-column air-delivery ports are connected to a thermal electric device.

FIG. 8 is a computing apparatus for use in connection with the present technology.

### DETAILED DESCRIPTION

As required, detailed embodiments of the present disclosure are disclosed herein. The disclosed embodiments are merely examples that may be embodied in various and alternative forms, and combinations thereof. As used herein, for example, exemplary, and similar terms, refer expansively to embodiments that serve as an illustration, specimen, model or pattern.

The figures are not necessarily to scale and some features may be exaggerated or minimized, such as to show details of particular components. In some instances, well-known components, systems, materials or methods have not been described in detail in order to avoid obscuring the present disclosure. Therefore, specific structural and functional details disclosed herein are not to be interpreted as limiting, but merely as a basis for the claims and as a representative basis for teaching one skilled in the art to employ the present disclosure.

While the present technology is described primarily in connection with automotive uses, the technology is not limited to automotive use. The technology may be used similarly in aircraft, marine craft, and other vehicles.

### Overview of the Disclosure

By various embodiments, the present disclosure describes an intra-vehicle, localized air-delivery system. The system is configured and arranged to direct air, conditioned as desired or determined appropriate, selectively and more directly to and about a driver of the vehicle.

Conventional air-control systems are configured to disperse air to generally an entirety of the cabin when desired. While conditioning air for the entire vehicle is sometimes desirable, it is not always, and is actually relatively rarely, needed. A vast majority of vehicles are driven with the driver as the only occupant. Some studies have found the percentage of driver-only vehicles on the road to be consistently over 80%.

Direct or localized air delivery is accomplished using one or more air ports, e.g., nozzles, positioned on or adjacent a steering assembly of the vehicle. In one embodiment, the air-control system is a part of or connected to a steering column of the vehicle.

The system allows fine control of a personalized climate for the driver within the vehicle. The climate controlled can also be referred to by other terms, such as local climate or microclimate. The system can be changed by the driver to quickly and efficiently create, or foster, the desired local climate for the driver. Efficiency, e.g., energy efficiency, is promoted by the air port(s) being positioned relatively close to the driver and configured to direct air more expressly to and about the driver as compared to conventional main heating, ventilating, and air-conditioning (HVAC) systems.

While HVAC is described mostly herein as including heating and cooling air, the present technology includes in various embodiments other types of climate control. Ventilating for instance can include initiating circulation or other movement or blowing of air of any temperature, even at a temperature that is the same generally as that of the cabin or temperature at or adjacent the driver. As another example, in addition to heating and cooling, the air conditioning can include controlling a humidity or aridity of the air being emitted by the on-steering-column system of the present technology. Other controllable air-related characteristics include breeze, circulation, and ventilation.

Efficiency is also promoted by energy-saving features of the technology. Energy is saved in ways, including by positioning air-delivery ports or nozzles relatively close to the driver.

For example, by the increased efficiency, energy is saved, because less conditioning of the air and/or less air flow (e.g., lower volume and/or lower flow rate) is needed. In other words, because the conditioned air will more quickly reach the driver, there will be less losses (e.g., warm air cooling or cool air warming) than if the conditioned air had to travel a greater distance. Other energy-saving aspects of the present technology are described below.

Energy can also be saved by using a main HVAC of the vehicle less and, at times, not at all, while using the localized air delivery system of the present disclosure.

Energy savings are also accomplished by being able to customize a microclimate for the driver without needing to bring substantially an entirety of a vehicle cabin, or even an entirety of a front portion of the cabin, to the desired climate condition.

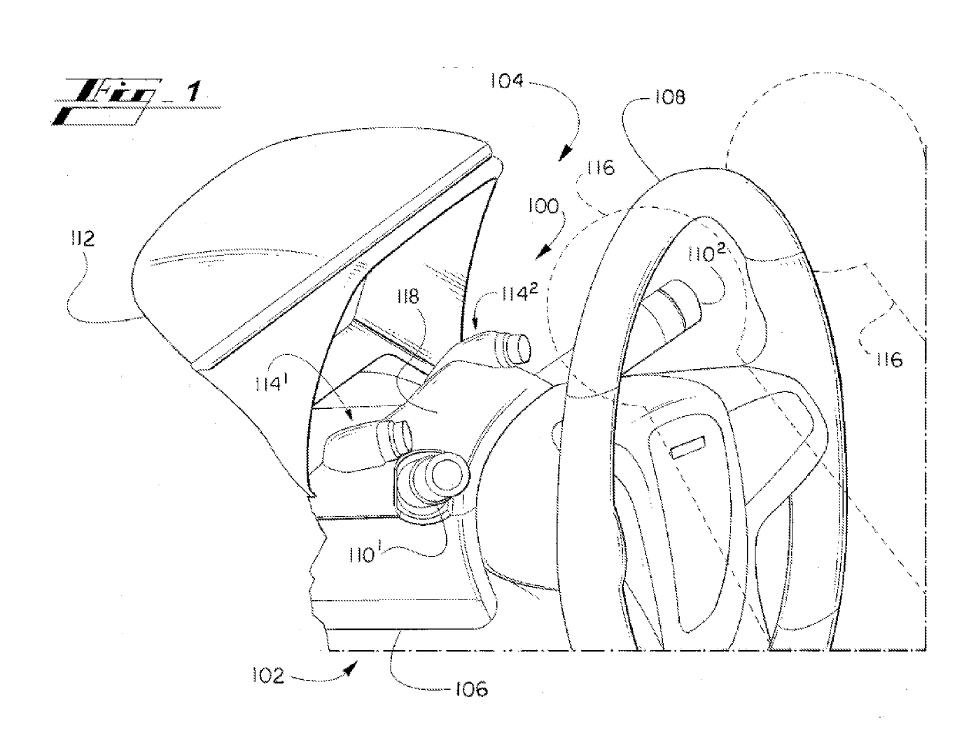

FIG. 1

FIG. 1 is a perspective view of a driver-focused air-delivery system installed in combination with a vehicle steering assembly, in accordance with embodiments of the present disclosure. The air-delivery system is identified in the figure by reference numeral 100.

The system 100 is shown in FIG. 1 as part of or connected to the steering assembly 102 of the vehicle 104, and more particularly to a steering column 106.

The steering assembly 102 includes a steering control 108, e.g., steering wheel, connected to the column 106 and also includes or is connected to side controllers 110¹, 110². In FIG. 1, superscripts 1 and 2 are used to represent, from a perspective of the driver 116, a left side and a right side of the system 100, respectively. The controllers 110¹, 110² can in many ways be like conventional side controllers for uses such as signaling lane change, menu control, wiper control, cruise control, etc.

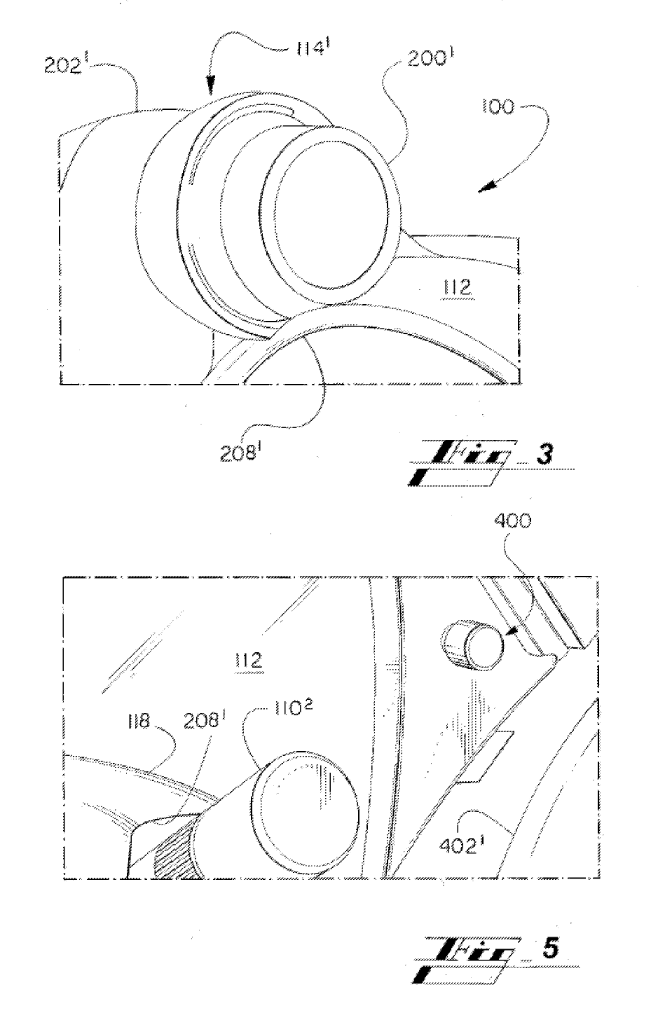

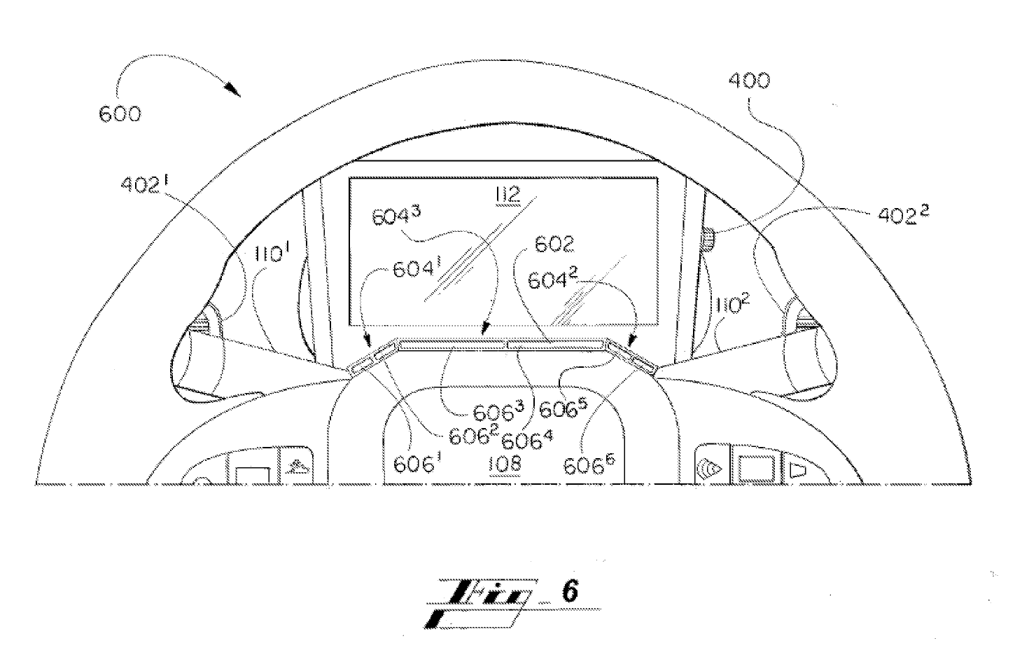

The vehicle 104 also includes adjacent the steering assembly 102, an instrument cluster or display apparatus 112. The instrument display apparatus 112 includes a screen (shown more in FIGS. 4 and 5) and may include a hood as shown in FIG. 1.

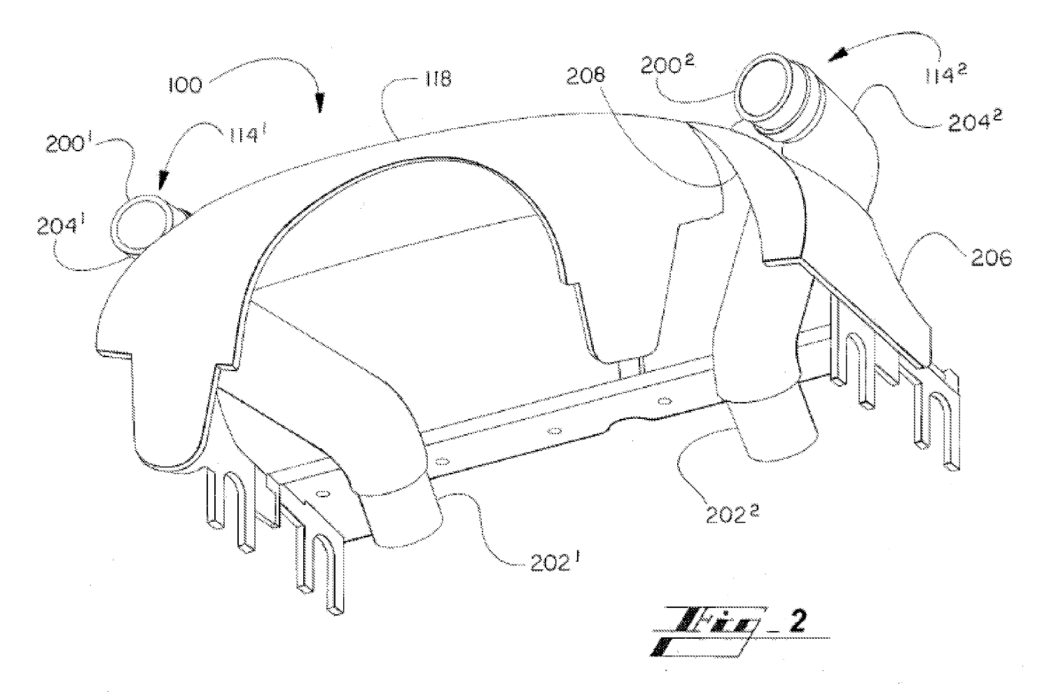

The driver-focused air-delivery system 100 includes one or more air-delivery components 114¹, 114². As with other parts described herein, the air-delivery component 114 may be referred to by other terms. Other terms include air-delivery ports or nozzles. The term port is used primarily hereinafter, without limiting the configuration of the air-delivery components, to describe the terminal opening part(s) (e.g., feature 200 in FIG. 2, et seq.) of the air-delivery component 114 from which air is finally delivered from the system 100.

In the illustrated embodiment, the air-delivery component or components 114¹, 114² are positioned to the left and/or right of a centerline of the steering column 106.

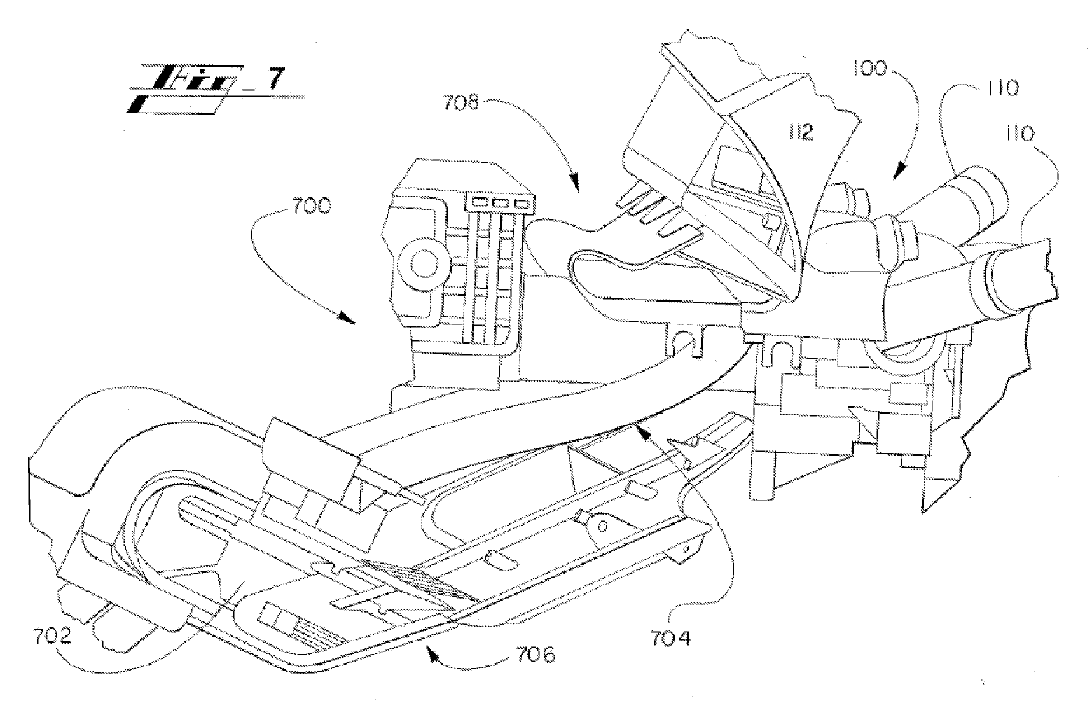

In one embodiment, the system 100 includes a central portion 118. The central portion 118 is configured to be low profile, at least by not including any air-delivery components, thereby not obstructing driver line of sight to, e.g., the instrument display apparatus 112. As shown clearly in the example embodiments of FIGS. 4 and 6, the ports are positioned so as not so obscure driver view of the instrument cluster 112.

In a contemplated embodiment (not shown in detail), the system 100 does not include a central portion 118. In this case, the air-delivery component or components 114¹, 114² of the system would still be part of or connected to the steering column, but there would be no material 118 connected to the port(s) and extending over top of the steering column 106. By this alternative design, too, then, driver line of sight is not obstructed by the system.

FIG. 2

FIG. 2 is a perspective view of the air-delivery system of FIG. 1 showing the system 100, separate from the steering assembly, from a low vantage point.

As referenced above, and called out in FIG. 2, each of the air-delivery components 114¹, 114² includes an air-delivery port, nozzle, or vent 200¹, 200². Each port 200¹, 200² is connected to or integral with at least one delivery conduit 202¹, 202².

The conduit is in some embodiments visible, or a cover of the conduit is visible, as indicated by reference numeral 204¹, 204². The visible portion or cover 204 extends above another system surface 206. Such features, e.g., surfaces and cover(s), can be referred to as body or frame components, or simply as a body or a frame.

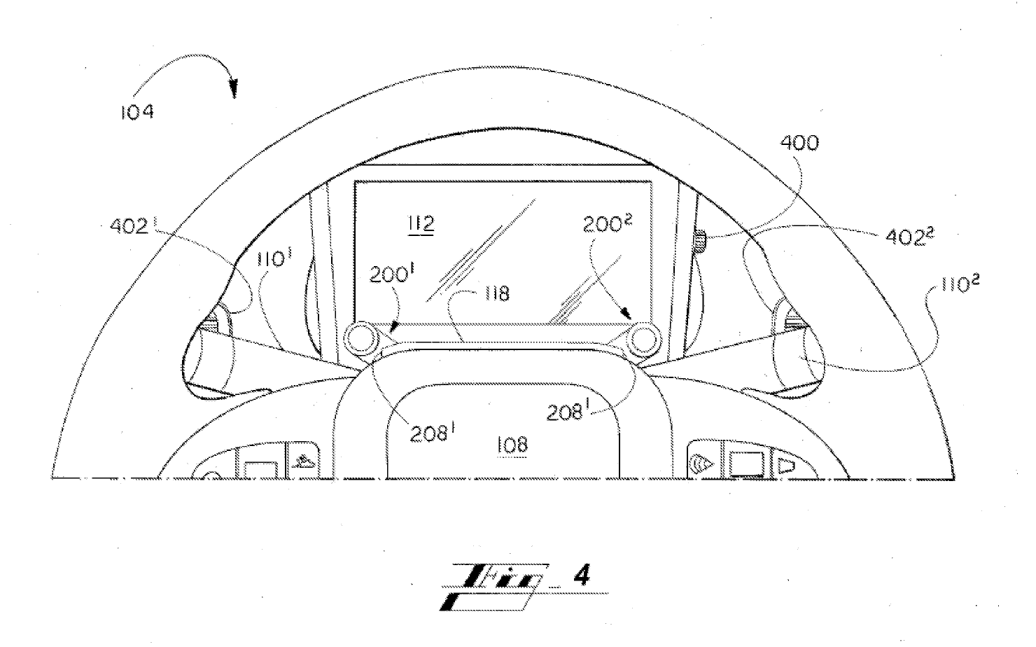

The system 100 in some embodiments also includes a right and/or left shoulder, or recess 208—e.g., a right-side shoulder 208² called out in FIG. 2, and a left-side shoulder 208¹ is shown in FIG. 3, and both are shown in FIGS. 1 and 4.

The air-delivery ports 200 are in various embodiments configured (e.g., shaped and sized) and arranged (e.g., positioned, connected to and/or with respect to other parts) according to a wide variety of considerations. A primary consideration is proximity to the driver. When the air-delivery ports 200 are closer to the driver, the air emitted therefrom reaches the driver more quickly, thereby affecting more quickly, and maintaining more efficiently, desired driver conditions corresponding to the air flowing from the ports.

By the increased efficiency, energy is saved, because less conditioning of the air and/or less air flow (e.g., lower volume and/or lower flow rate) is needed. In other words, because the conditioned air will more quickly reach the driver, there will be less losses (e.g., warm air cooling or cool air warming) than if the conditioned air had to travel a greater distance. Other energy-saving aspects of the present technology are described below.

In this way, the current technology facilitates occupant climate (e.g., thermal) comfort in an improved manner by delivering conditioned air from a system having a port being closer to the human body, and delivering the air more directly to the person, particularly closer and more directly to the face and hands, and perhaps also the chest of the driver.

Regarding the hands for example, the air-delivery ports 200 can be configured and arrange, or changed by the driver, to deliver air, conditioned as desired, to or adjacent the hands, such as to warm them. This can be especially helpful, e.g., on very cold days. Warming the hands in this way has benefits above warming the hands by heated steering wheel, including in the fact that hands warmed by a heated steering wheel continue to be exposed on their backsides to the cold cabin temperature until the cabin temperature is warmed.

The technology, in these and other described manners, allows efficient and fast creation, or fostering, of a desired microclimate around the driver that can be controlled easily based on the individual comfort need.

Factors limiting how close the air-delivery ports 200 can be positioned with respect to the driver include the need to avoid contact with structure of static or movable vehicle components, such as the steering wheel 108 and the side controllers 110, driver line of sight, and appearance or aesthetics.

Another variable, or consideration, for configuring and arranging the port(s) 200 is angle of air delivery. The air-delivery ports 200 are in some embodiments configured and arranged to deliver air primarily toward a driver of the vehicle. In being directed primarily toward the driver, portions of the air may disperse about the driver and may also flow directly or indirectly (e.g., after being redirected by the driver's body) to other parts of the cabin including toward a rear seating compartment, toward a driver leg and foot area, toward the windshield, toward the front passenger area, etc.

Related to port angle, and in addition to avoiding contact with other vehicle structures, the port(s) 200 are configured and arranged with consideration to how the air flows with respect to such structures—e.g., adjacent, over, under, past, into, or through the steering wheel, the steering column, the side controllers, etc. In some embodiments it is generally preferred that the air-delivery ports 200 be configured and arranged so that a minimum volume of air leaving the ports is affected (e.g., redirected, blocked) by the other structures.

Another consideration in port(s) design is size and shape of the ports and how they affect desired characteristics such as flow rate, volume, and, again, direction of the air flowing from the port(s).

Features of the source plumbing 202 also affect flow rate and volume, as does system features further upstream—e.g., upstream blower or fan, characteristics and function of other upstream outtakes from the plumbing 202 (to, e.g., dash vents, shown in FIGS. 4-6), etc.

Shape or profile of the air, e.g., air column, leaving the port(s) is also affected, and so the port(s) can be designed to reach a desired result—e.g., an air dispersion profile having a broader cone shape, a thinner or tighter cone shape, etc. As described further below in connection with FIG. 6, the ports can have shapes other than circular as show in FIGS. 1-4, such as rectangular. The ports can also be stacked, arranged in a matrix, or other configurations, as described further below with reference to FIG. 6.

In one embodiment, the air-delivery ports 200 are multi-directional, being adjustable in one or more manners so that the driver can customize the air-delivery direction or directions. In a particular embodiment, e.g., the port(s) 200 are adjustable manually by the driver. In another embodiment, in addition to or instead of being adjustable manually, each port is adjustable by at least one actuator (not shown in detail) that is connected to the port and controllable by the driver, such as by a dashboard control, touch-screen display, voice commands, etc.

The air-delivery ports 200 may be adjustable in any of multiple directions in various embodiments, including up, down, left, and right. In some cases, the port(s) are adjustable in direction between laterally and vertically, such as being movable in 360 degrees. By adjusting the port(s), the driver can customize the direction that the air leaves the ports toward him/her.

As described further below in connection with FIG. 5, the vehicle 104 can include controls by which the driver and/or vehicle itself can control an amount of air that is delivered from a main HVAC source to the port(s) particular to the present disclosure versus, for instance, another destination such as dashboard vents also shown in FIGS. 4-6.

FIG. 3

FIG. 3 is a close-up view of one of the air-delivery ports of the air-delivery system. As referenced, the air-delivery port 200 of the illustrated embodiment is generally circular, and can be referred to also as a nozzle. The port, e.g., nozzle, can be configured to cause air to emit from the system in a jet-like fashion. The air-delivery port 200 in some cases has other shapes, such as more elongate, e.g., oval or rectangle, such as shown in FIG. 5.

FIG. 3 also shows the shoulder 208 for accommodating the side controller, which is not shown in the figure.

FIGS. 4 and 5

FIG. 4 is a driver-perspective of the air-delivery system 100 installed on a vehicle 104. FIG. 5 is a perspective view showing a control mechanism, for activating or adjusting the air-delivery system, mounted on an instrument cluster hood of the vehicle. The views show an adjustment component 400 and dashboard vents 402¹, 402² in addition to the ports or ports 200¹, 200².

As referenced, the one or more air-delivery components 114, or at least the air-delivery ports 200, are spaced as mentioned to, at least in part, avoid obscuring diver's line of sight. In the illustrated case, the system 100 includes two ports 200 spaced from a center of the steering column/steering wheel so as to avoid blocking driver view of the cluster 112.

In another embodiment, not shown in detail, the system 100 includes a single port. The system could include, for instance, only the left or only the right port 200¹, 200² of FIG. 4. In other embodiments, the system 100 includes one, two, three or more ports positioned in these or other non-blocking locations on or adjacent the steering column 106.

The adjustment component 400 shown is an example user-system interface, or vehicle-system interface, by which the driver can control at least the amount of air that flows from the port(s). In the illustrated example, the component 400 is a rotatable knob positioned on a side of the hood of the instrument panel 112.

Other contemplated positions include, e.g., a location on the steering wheel or steering assembly other than that shown, a location on a center console, and a dashboard location such as in or adjacent the area in which HVAC controls typically are located. Other example adjustment components include a touch-screen display and a voice command system. (not shown in detail)

In one embodiment, the air-delivery components 114 themselves are each configured to allow the driver to adjust flow, and so act as the adjustment component 400. As just an example, each nozzle 200 can be configured with, e.g., a rotatable bezel or frame, to be turnable like the knob 400 shown, or otherwise movable, to control air flow.

In one embodiment, the adjustment component, whether the illustrated knob, the nozzles themselves, or other, when turned in a first direction results in an increase in the amount air flowing from a main HVAC source toward the ports. The system can be configured so that air is also directed to other destinations, such as dashboard openings 402, and in one embodiment, by directing more to the ports of the present technology, less is directed toward the other destinations. And, vice versa—the knob when turned in a second direction results in a decrease in the amount air flowing from a main HVAC source toward the ports, which can be accompanies then by more air being directed toward the other destinations.

The turning is linked to flow-affecting apparatus, not shown in detail, affecting selectively flow of air to, through, and/or out of the nozzles. The control can also affect, directly or indirectly, an amount of air flowing from the other HVAC openings—e.g., dash vents at desired volumes or flow rates anywhere between 0 and 100%.

An example flow-affecting apparatus includes valve components (e.g., flaps), such as of a Y-valve. The apparatus can be pneumatically controlled, by electric actuator, or otherwise. In one embodiment, automatic controls of the valve can be configured so that air, e.g., source air, is used in a manner to obtain the desired microclimate in as efficient a manner as possible. The system can be configured to consider efficiency at all times or under pre-determined conditions, such as when the system is in an efficiency or green mode that can be programmed into code, or instructions of the computing device.

In some embodiments, the system is configured to control air flow by being connected to the flow-affecting apparatus. The control interface for these embodiments can include the adjusting component 400 as shown or other configurations, such as by including a touch-sensitive display or a voice system.

As can be appreciated from FIGS. 5 and 6, the port(s) 200 have much greater proximity to the driver as compared to the dashboard vents. Benefits of greater proximity are mentioned above—when the air-delivery ports 200 are closer to the driver, the air therefrom reaches the driver more quickly, thereby affecting more quickly and maintaining more efficiently desired driver conditions corresponding to the air flowing from the ports. Factors limiting how close the air-delivery ports 200 can be positioned with respect to the driver include the need to avoid contact with other structure, e.g., static or movable vehicle components, such as the steering wheel 108 and the side controllers 110, driver line of sight, and appearance or aesthetics.

FIG. 6

FIG. 6 is a driver-perspective like that of FIG. 4 of a vehicle having installed thereon an air-delivery system 600 according to another embodiment of the present technology.

The system 600 includes alternative air-delivery components comprising ports 602 being elongate and generally rectangular as a particular example.

As mentioned, the ports can be stacked, clustered, in a matrix, or arranged otherwise. In FIG. 6, the ports 602 are positioned as part of three air-delivery or port clusters 604—a left cluster 604¹, a right cluster 604², and a central 604³. By way of example, each cluster 604 includes two openings, a right and left opening 606¹⁻⁶.

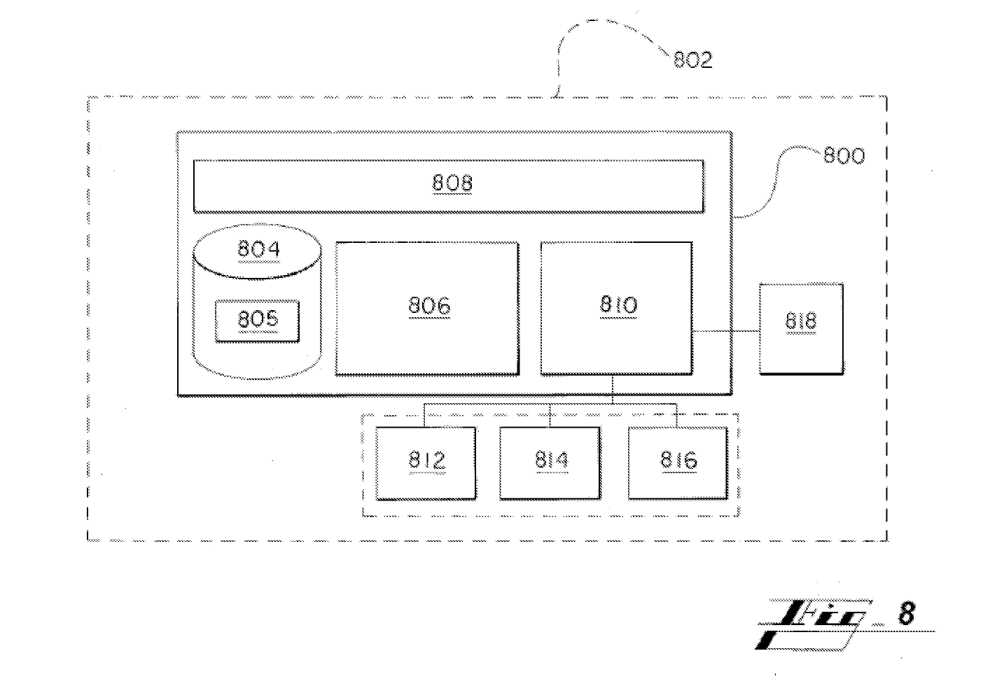

FIG. 7

FIG. 7 is a perspective view of an alternative arrangement or system 700 wherein steering-column ports—e.g., nozzles—are connected to a thermoelectric device. The arrangement 700 includes a system 100 that can include any of the aspect described above, including in connection with FIGS. 1-6.

The arrangement 700 includes an ancillary air temperature-changing device 702, such as a thermoelectric (TE) device, or TED. While other temperature changing devices can be used, the device 702 is referred to primarily herein as the TE device for convenience. The TE device 702 can heat and/or cool before it is introduced to the steering-column delivery system 100.

In operation, TE devices convert electrical voltage to temperatures such as by input voltages of a first polarity causing the TE device to heat, and so heat air that is in, adjacent, or passing through the TE device. And input voltages of a second polarity cause the TE device to cool, and so cool air that is in, adjacent, or passing through the TE device.

The arrangement includes plumbing, such as piping or tubing, 704 connecting the TE device 702 and the on-column system 100 for delivering the air leaving the TE device 702 to the air-delivery ports—e.g., nozzles.

The TE device 702 includes or is connected to a fan, pump, blower, or other air propulsion component 706 for motivating air through the plumbing 704. In one embodiment, the component 706 and/or the TE device 702 is connected, such as by one or more vents (not shown in detail) to a cabin of the vehicle (e.g., adjacent a drivers feet or the driving pedals, from which it receives input air for passing through the TE device an on, conditioned, through the plumbing 704.

While the TE path is shown to include the TE device 702 positioned adjacent the driver foot well region, the TED can be positioned in other locations, such as at or adjacent where a main HVAC source is or would be located, elsewhere behind the dash, or other.

One consideration for TE device location is that it is generally preferable to position the TE device as close to the ports—e.g., nozzles—as possible. One benefit of such positioning is that the air leaving the TE device travels less distance, and so the conditioning affected by the TE is delivered to the ports more quickly, and so before much of the conditioning is dissipated in transport.

Another consideration for TE device positioning is that when the TE device is closer to the output ports of the system 100, and so there will be less of the mentioned losses due to distance, less energy is required to condition the air sufficiently for delivery from the system 100 as desired. In this way, energy can be saved not only by the relatively close proximity of the ports (e.g., nozzles) of the system 100 to the driver, but also or instead by conditioning air without using or using to a minimum degree the main HVAC.

The TE device 702 can be included in the arrangement 700 as a primary or supplementary temperature control device. In one embodiment, for instance, the on-column system 100 is connected to both a main HVAC source (not shown), delivering conditioned air to the system and to the TE device. In a particular embodiment, air from the main HVAC can be provided via a main path as the primary source for delivering air by the on-column system, and the TED path can be used to supplement the main path as needed. When air from the HVAC is not warm enough, or not cool enough, to condition the air sufficiently or as quickly as needed or desired, for instance, the TE device path can be activated to replace or supplement the main path, providing, or adding extra, sufficiently conditioned air as needed.

Activation of the TE device path is in various implementations manual and/or automatic. Manual activation can be performed via a knob, touch-screen, voice system, or other control part as described above regarding air-flow control. The TE device is connected to circuitry and/or computing apparatus controlling the temperature that the TE device is operated at, which, again, can be controlled by an amount and polarity of input voltage. An example computing apparatus is shown and described in connection with FIG. 8. The circuitry or computing apparatus can be the same as that controlling the temperature of air provided by the main HVAC path, for instance.

In a contemplated embodiment, one or more HVAC functions are performed via the main HVAC path while another one or more functions are performed via the TED path. The main HVAC path may be used to condition a humidity or moisture level of air delivered to the on-column system 100, for instance, while the TED path is used to condition air temperature (e.g., heat or cool).

In another particular embodiment using the TE device, the on-column air-delivery system 100 is connected to the TED and not connected to a main HVAC source. In this case, all air conditioning functions (e.g., heating and cooling, and perhaps other functions such as controlling moisture level, etc.) are performed in the TED path.

FIG. 8

FIG. 8 shows an example computing device 800. The device 800 is part of the vehicle 802 and, like any part described herein, can be considered a sub-system of a general system of the present technology.

The device 800 includes a computer-readable memory, such as a tangible or non-transitory computer-readable storage device 804 storing computer-executable instructions 805. The device 800 also includes a processor 806 in communication by a channel 808 with the memory, such as a wired bus or wireless infrastructure, e.g., wireless transceivers.

The processor 806 is configured to execute the instructions 805 to perform operations stipulated by the instructions for performing any of the functions described, required, or apparent based on the descriptions of the present technology provided herein.

The device 800 also includes an interface 810 for sending, or sending and receiving communications, signals, and/or data from and to the device 800. Extra-device apparatus that may communicate with the interface 810 can include an air conditioning controller 812 (e.g., TED, main HVAC heating/cooling element, humidity controller, etc.), air-delivery port selection controller 814, and air-delivery directional controller 816. Example input components include driver-vehicle interfaces 818 such as an air-quality interface, controlling temperature and humidity/aridity, for instance, and an air-flow-rate control component. Each interface may take the form of one or more components, such as a knob, like the illustrated adjustment component 400, a touch-sensitive display, a voice control sub-system, etc.

### Select Features of the Technology

In this section, some of the advantages of the present technology that are described above are further emphasized and some additional benefits are mentioned. These benefits are not comprehensive, but merely illustrative of the advantages of the present technology.

Benefits of the technology include being able to obtain a faster and improved climate (e.g., temperature) comfort, to enable personalized microclimate control, and to save HVAC energy usage by using less of a main central HAVC power.

The proposed design delivers conditioned air to the occupant-focused target cooling/heating area more effectively due to its proximity to the occupant.

Occupant comfort, such as regarding temperature, humidity, breeze, circulation, ventilation, etc., is improved by user-adjustable port control and efficient use of air distribution.

In addition to the increased driver comfort, localized climate delivery can potentially save energy costs. When combined with localized TE air supply, the proposed design can reduce HVAC power consumption without compromising occupant climate comfort. When combined with localized TE air supply, the proposed design can reduce HVAC power consumption without compromising occupant climate comfort. Energy is saved, for example, when a main HVAC system of the vehicle is turned off and driver comfort is maintained or enhanced using the localized air-delivery system of the present technology, which draws less power. Even if the main HVAC system is left on, but used less (e.g., turned down), energy can be saved by maintaining user comfort by supplementing the main system with the localized air-delivery system.

Energy can also be saved by adjusting position of the adjustable ports—e.g., nozzles. When the ports are closer to the driver, the air therefrom reaches the driver more quickly, thereby affecting more quickly and maintaining more efficiently desired driver conditions corresponding to the air flowing from the ports. By the increased efficiency, energy is saved, as less conditioning of the air and/or less air flow (e.g., lower volume and/or lower flow rate) is needed, because the conditioned air will more quickly reach the driver, and so there will be less losses (e.g., warm air cooling or cool air warming) than if the conditioned air had to travel a greater distance.

The technology facilitates occupant climate comfort in an improved manner by delivering conditioned air closer to the human body, particularly to the face and hands, and perhaps also the chest of the driver.

The advantages are also accomplished using the steering column in a manner that does not obscure driver view, such as line of sight to the instrument cluster.

By the energy savings enabled, the technology also thereby improves the vehicle power rating, particularly its HVAC system power rating.

### CONCLUSION

Various embodiments of the present disclosure are disclosed herein. The disclosed embodiments are merely examples, which may be embodied in various and alternative forms, and combinations thereof, and which are set forth for a clear understanding of the principles of the disclosure.

Variations, modifications, and combinations may be made to the above-described embodiments without departing from the scope of the claims. All such variations, modifications, and combinations are included herein by the scope of this disclosure and the following claims.

What is claimed is:

1. A system, for fostering a customized driver microclimate for a driver of a vehicle, comprising:
a steering column;
a body connected to or constituent to the steering column;
an input conduit; and
an air-delivery port connected to the input conduit and configured and connected to the body to, during operation of the system, receive air from the input conduit and deliver the air from a vicinity of the steering column toward a vicinity of the driver to foster the microclimate.

2. The system of claim 1 wherein:
the air source includes a main heating, ventilating, and air conditioning (HVAC) source connected to vehicle HVAC vents distinct from the air-delivery port; and
the air source comprises a thermoelectric (TE) device.

3. The system of claim 2 further comprising at least one sub-system selected from a group consisting of:
a user-system interface configured and arranged to, during operation of the system, allow selective driver control of an amount of air received at the air-delivery port from the main HVAC source versus an amount of air received at the air-delivery port from the TE device; and
an automated sub-system configured and arranged in the system to, during operation of the system, control an amount of air received at the air-delivery port from the main HVAC source versus an amount of air received at the air-delivery port from the TE device.

4. The system of claim 1 wherein the system, in being configured to deliver the air from the vicinity of the steering column toward the driver during operation of the system, is configured to deliver air directly to a hand of the driver grasping a vehicle steering control connected to the steering column.

5. A system, for fostering a customized driver microclimate for a driver of a vehicle, comprising:
a body;
an air-delivery conduit connected to the body; and
an air-delivery port connected to the body and to the air-delivery conduit;
wherein the system is configured to:
connect to or be constituent to a steering column of the vehicle;
receive air into the air-delivery conduit from an air source during operation of the system; and
deliver the air from a vicinity of the steering column toward the driver to foster the microclimate during operation of the system.

6. The system of claim 5 wherein:
the air source includes a main heating, ventilating, and air conditioning (HVAC) source connected to vehicle HVAC vents distinct from the air-delivery port; and
the air source comprises a thermoelectric (TE) device.

7. The system of claim 6 further comprising at least one sub-system selected from a group consisting of:
a user-system interface configured and arranged to, during operation of the system, allow selective driver control of an amount of air received at the air-delivery port from the main HVAC source versus an amount of air received at the air-delivery port from the TE device; and
an automated sub-system configured and arranged in the system to, during operation of the system, control an amount of air received at the air-delivery port from the main HVAC source versus an amount of air received at the air-delivery port from the TE device.

8. The system of claim 5 wherein the system, in being configured to deliver the air from the vicinity of the steering column toward the driver during operation of the system, is configured to deliver air directly to a hand of the driver grasping a vehicle steering control connected to the steering column.

9. A system, for fostering a customized driver microclimate for a driver of a vehicle, comprising:
a body; and
an air-delivery port connected to the body;
wherein the system is configured to:
connect to or be constituent to a vehicle steering column;
receive air from an air source during operation of the system; and
deliver the air from a vicinity of the steering column toward the driver to foster the customized driver microclimate during operation of the system.

10. The system of claim 9 further comprising the steering column.

11. The system of claim 9 wherein the air-delivery port has an opening shape selected from a group of shapes consisting of:
generally circular;
generally rectangular; and
generally oval.

12. The system of claim 9 further comprising the air source, the air source including a thermoelectric device.

13. The system of claim 9 further comprising at least one other air-delivery port, wherein, when the system is installed in the vehicle, each of the air-delivery ports is positioned atop the steering column and spaced laterally from a fore-aft centerline atop the steering column to deliver air toward or over a top of a vehicle steering control, connected to the steering column, without the air-delivery ports obscuring a line of sight for the driver to an instrument cluster of the vehicle.

14. The system of claim 9 further comprising at least two other air-delivery port, wherein, when the system is installed in the vehicle, each of the air-delivery ports is positioned atop the steering column and spaced laterally from a fore-aft centerline atop the steering column to deliver air toward or over a top of a vehicle steering control, connected to the steering column, without the air-delivery ports obscuring a line of sight for the driver to an instrument cluster of the vehicle.

15. The system of claim 9 further comprising at least five other air-delivery port, wherein, when the system is installed in the vehicle, each of the air-delivery ports is positioned atop the steering column and spaced laterally from a fore-aft centerline atop the steering column to deliver air toward or over a top of a vehicle steering control, connected to the steering column, without the air-delivery ports obscuring a line of sight for the driver to an instrument cluster of the vehicle.

16. The system of claim 9 further comprising a user-system interface configured and arranged to allow driver control of one or both of an amount and a temperature of air delivered from the air-delivery port.

17. The system of claim 9 wherein the air source includes a main heating, ventilating, and air conditioning (HVAC) source connected to vehicle HVAC vents distinct from the air-delivery port.

18. The system of claim 17 wherein:
the air source comprises a thermoelectric (TE) device; and
the system further comprises at least one sub-system selected form a group consisting of:
a user-system interface configured and arranged to, during operation of the system, allow selective driver control of an amount of air received at the air-delivery port from the main HVAC source versus an amount of air received at the air-delivery port from the TE device; and
an automated sub-system configured and arranged in the system to, during operation of the system, control an amount of air received at the air-delivery port from the main HVAC source versus an amount of air received at the air-delivery port from the TE device.

19. The system of claim 9 wherein the air-delivery port, when the system is installed in the vehicle, is positioned at a central upper vicinity of the steering column and has a generally flat profile to deliver air from a vicinity of the steering column toward, over, or through a vehicle steering control, connected to the steering column, without the air-delivery port obscuring driver view of a vehicle instrument display.

20. The system of claim 9 wherein the system, in being configured to deliver the air from the vicinity of the steering column toward the driver during operation of the system, is configured to deliver air directly to a hand of the driver grasping a vehicle steering control connected to the steering column.
